(19) United States
(12) Patent Application Publication
(10) Pub. No.: US 2026/0270826 A1
(43) Pub. Date: Sep. 10, 2026

(54) MULTIPLE RLF DETECTIONS FOR L1/L2 INTER-CELL MOBILITY

(71) Applicant: Telefonaktiebolaget LM Ericsson (publ), Stockholm (SE)

(72) Inventors: Antonino Orsino, Jorvas (FI); Icaro Leonardo Da Silva, Solna (SE); Pontus Wallentin, Linköping (SE)

(21) Appl. No.: 19/103,344

(22) PCT Filed: Aug. 16, 2023
(86) PCT No.: PCT/SE2023/050829

§ 371 Date: Feb. 12, 2025

Related U.S. Application Data
(60) Provisional application No. 63/399,091, filed on Aug. 18, 2022.

(51) Int. Cl. H04W 36/08

(52) U.S. Cl. CPC H04W 36/087

(57) ABSTRACT

In an embodiment, a method performed by a User Equipment device configured with one or more L1/L2 inter-cell mobility candidate cells for performing Radio Link Monitoring (RLM) and Radio Link Failure (RLF) detection is provided. The method can include receiving one or more L1/L2 inter-cell mobility candidate cell configurations. The method can also include performing a plurality of RLM processes based on parameters of one or more of a serving cell configuration and one or more of the L1/L2 inter-cell mobility candidate cell configurations. The method can also include declaring an RLF on one or more of the serving cell or the one or more L1/L2 inter-cell mobility candidate cells. The method can also include performing a network operation based on a type of the RLF.

### RELATED APPLICATIONS

This application claims the benefit of provisional patent application Ser. No. 63/399,091, filed Aug. 18, 2022, the disclosure of which is hereby incorporated herein by reference in its entirety.

### TECHNICAL FIELD

The present disclosure relates to performing radio link monitoring and radio link failure detection for L1/L2 inter-cell mobility cells in a wireless communications system.

### BACKGROUND

### Radio Link Monitoring (RLM) Handling in NR

In New Radio (NR), Radio Link Monitoring (RLM) is also defined for a similar purpose as in Long Term Evolution (LTE), i.e. monitor the downlink radio link quality of the serving cell (more precisely the SpCell, i.e. PCell and PSCell if the User Equipment device (UE) is configured with Multiple-Radio Dual Connectivity) in a Radio Resource Control (RRC)_CONNECTED state.

RLM is performed by the lower layers at the UE (L1—layer 1, physical layer). The UE performs measurements (e.g., Signal to Interference and Noise Ratio (SINR)) that when its quality is poor (according to a hypothetical PDCCH Block Error Rate threshold) the lower layers at the UE generate an out of sync (OOS) indication to higher layer, which maintains a counter. Similarly, when the quality improves (according to another hypothetical Physical Downlink Control Channel (PDCCH) Block Error Rate threshold) the UE generate an in sync (IS) indication to higher layer, which maintains another counter. These counters are used by higher layers to determine whether or not a radio link failure should be declared.

To perform are the so-called Cell-specific Reference Signals (CRS) defined per cell. Differently from LTE, some level of configurability has been introduced for RLM in NR in terms of Reference Signal (RS) type/beam/RLM resource configuration and Block Error Rate (BLER) thresholds for IS and Out of Sync (OOS) generation.

### Explicit RLM Configuration

In NR, two types of reference signals (RS Types) are defined for L3 mobility: Physical Broadcast Channel (PBCH)/Synchronization Signal Block—SS Block (SSB or SS Block), which basically comprises synchronization signals equivalent to primary synchronization signal (PSS) and secondary synchronization signal (SSS) in LTE and PBCH/Demodulation Reference Signal (DMRS), and, Channel State Information Reference Signal (CSI-RS) for L3 mobility, more configurable and configured via dedicated signaling. There are different reasons to define the two RS types, one of them being the possibility to transmit SSBs in wide beams while CSI-RSs in narrow beams.

In NR, the RS type used for RLM is also configurable and both CSI-RS based RLM and SS block based RLM are supported. In the case of CSI-RS, the time/frequency resource and sequence can be used. As there can be multiple beams, the UE needs to know which ones to monitor for RLM and how to generate IS/OOS events. In the case of SSB, each beam can be identified by an SSB index (derived from a time index in PBCH and/or a PBCH/DMRS scrambling). The network can configure by RRC signalling, X RLM resources, either related to SS blocks or CSI-RS, as follows:
One Radio Link Monitoring Reference Signal (RLM-RS) resource can be either one PBCHSS block or one CSI-RS resource/port;
The RLM-RS resources are UE-specifically configured at least in case of CSI-RS based RLM;
When UE is configured to perform RLM on one or multiple RLM-RS resource(s),
   Periodic IS is indicated if the estimated link quality corresponding to hypothetical PDCCH BLER based on at least Y RLM-RS resource(s) among all configured X RLM-RS resource(s) is above Q_in threshold;
   Periodic OOS is indicated if the estimated link quality corresponding to hypothetical PDCCH BLER based on all configured X RLM-RS resource(s) is below Q_out threshold;
      That points in the direction that only the quality of best beam really matters at every sample to generate OOS/IS events.

Note: RLM is not defined for SCells, only for SpCells, i.e., if the UE is in single connectivity, RLM is performed only on the PCell. If the UE is configured with MR-DC, RLM is performed on both the PCell and the PSCell.

Resources or RLM can be configured via RRC TS 38.331 as part of the SpCellConfig, within each dedicated BWP configuration—BWP-DownlinkDedicated, in an RRCReconfiguration or RRCResume message) within the RadioLinkMonitoringConfig IE, as follows:

```
RadioLinkMonitoringConfig ::= SEQUENCE {
    failureDetectionResourcesToAddModList SEQUENCE (SIZE(1..maxNrofFailureDetectionResources) )
OF RadioLinkMonitoringRS OPTIONAL, -- Need N
failureDetectionResourcesToReleaseList SEQUENCE (SIZE(1..maxNrofFailureDetectionResources) ) OF
RadioLinkMonitoringRS-Id OPTIONAL, -- Need N
}
RadioLinkMonitoringRS ::= SEQUENCE {
    radioLinkMonitoringRS-Id RadioLinkMonitoringRS-Id,
    purpose ENUMERATED {beamFailure, rlf, both},
    detectionResource CHOICE {
        ssb-Index SSB-Index,
        csi-RS-Index NZP-CSI-RS-ResourceId
    },
    ...
}
```

Each so-called RLM resource of an SpCell that needs to be monitored is configured in the IE RadioLinkMonitoringRS, wherein the UE is configured either with an SSB index or a CSI-RS index. These resources are equivalent to the downlink beams/spatial directions transmitting the reference signals (SSBs) associated to these indexes. And each of these beams are also used for transmission of control channel(s) for that cell (e.g., PDCCH) so that performing RLM is equivalent to assessing the quality of control channel for that cell.

### Implicit RLM Configuration

According to TS 38.331, if an explicit list of RSs is not configured for RLM, the UE monitors the reference signal(s) configured as Quasi-co-location (QCL) of currently active Transmission Configuration Indicator (TCI) states configured for the PCell or PSCell. This is described in RRC in the field description below:

RadioLinkMonitoringConfig field descriptions

failureDetectionResourcesToAddModList
A list of reference signals for detecting beam failure and/or cell level radio link failure (RLF). [...] If no RSs are
provided in this list for the purpose of RLF detection, the UE performs Cell-RLM based on the activated TCI-
State of PDCCH as described in TS 38.213 [13], clause 5. The network ensures that the UE has a suitable set
of reference signals for performing cell-RLM.

As described in TS 38.213, if the UE is not provided RadioLinkMonitoringRS and the UE is provided for PDCCH receptions TCI states that include one or more of a CSI-RS
the UE uses for radio link monitoring the RS provided for the active TCI state for PDCCH reception if the active TCI state for PDCCH reception includes only one RS
if the active TCI state for PDCCH reception includes two RS, the UE expects that one RS is configured with qcl-Type set to ‘typeD’ [6, TS 38.214] and the UE uses the RS configured with qcl-Type set to ‘typeD’ for radio link monitoring; the UE does not expect both RS to be configured with qcl-Type set to ‘typeD’
the UE is not required to use for radio link monitoring an aperiodic or semi-persistent RS
For Lₘₐₓ=4, the UE selects the N_{RLM} RS provided for active TCI states for PDCCH receptions in CORESETs associated with the search space sets in an order from the shortest monitoring periodicity. If more than one CORESETs are associated with search space sets having same monitoring periodicity, the UE determines the order of the CORESET from the highest CORESET index as described in clause 10.1.

The RS for a TCI state is configured as follows:

TCI-State information element

```
-- ASN1START
-- TAG-TCI-STATE-START
TCI-State ::= SEQUENCE {
    tci-StateId TCI-StateId,
    qcl-Type1 QCL-Info,
    qcl-Type2 QCL-Info
OPTIONAL,  -- Need P
    ...
}
QCL-Info ::= SEQUENCE {
    cell ServCellIndex
OPTIONAL,  -- Need R
    bwp-Id BWP-Id
OPTIONAL, -- Cond CSI-PS-Indicated
    referenceSignal CHOICE {
        csi-rs NZP-CSI-RS-ResourceId,
        ssb SSB-Index
    },
    qcl-Type ENUMERATED {typeA, typeB, typeC, typeD},
    ...
}
-- TAG-TCI-STATE-STOP
-- ASN1STOP
```

And, the TCI state is considered activated based on reception of MAC CE(s) (see TS 38.321 for further details on MAC CE activation of TCI states).

### Out of Sync (OOS) and in Sync (IS) Indications Based on RLM Resources

For both implicit and explicit RLM configurations, the UE performs monitoring of the resources and evaluates the conditions whether radio link is suitable for the RRC connection or not.

In non-Discontinuous Reception (DRX) mode operation, the physical layer in the UE assesses once per indication period the radio link quality, evaluated over the previous time period defined in TS 38.133 against thresholds (Qₒᵤₜ and Qᵢₙ) configured by rlmInSyncOutOfSyncThreshold. The UE determines the indication period as the maximum between the shortest periodicity for radio link monitoring resources and 10 msec.

In DRX mode operation, the physical layer in the UE assesses once per indication period the radio link quality, evaluated over the previous time period defined in TS 38.133, against thresholds (Qₒᵤₜ and Qᵢₙ) provided by rlmInSyncOutOfSyncThreshold. The UE determines the indication period as the maximum between the shortest periodicity for radio link monitoring resources and the DRX period.

The physical layer in the UE indicates, in frames where the radio link quality is assessed, out-of-sync (OOS) to higher layers when the radio link quality is worse than the threshold Qₒᵤₜ for all resources in the set of resources for radio link monitoring. When the radio link quality is better than the threshold Qᵢₙ for any resource in the set of resources for radio link monitoring, the physical layer in the UE indicates, in frames where the radio link quality is assessed, in-sync to higher layers.

### Radio Link Failure Due to Physical Layer Problems

FIG. 1 depicts an example situation where a Radio Link Failure is declared. The higher layer (RRC) receives the OOS and IS indications from the lower layers (L1, physical layer), as described above. After a configurable number (N310) 102 of such consecutive OOS indications, a timer (T310) is started at 104. If the link quality is not improved (recovered) while T310 is running (i.e., there are no N311 consecutive “in-sync” indications at 106 from the physical layer), a radio link failure is declared at 108 in the UE.

Upon declaring RLF in the PCell, the UE initiates re-establishment or, if configured with MR-DC and if configured with MCG failure reporting, it reports an MCG failure to the PSCell. Upon declaring RLF in the PSCell (also named S-RLF), the UE initiates an SCG Failure Report via the PCell.

### L1-L2 Based Inter-Cell Mobility in Rel-18

In Rel-18, 3GPP has agreed on a Work Item on Further New Radio (NR) mobility enhancements, in particular, in a technical area entitled L1/L2 based inter-cell mobility. See the Work Item Description RP-213565 for further details.

According to the WID, when the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling, in order to reduce the latency, overhead and interruption time.

L1-L2 inter-cell mobility should be, if possible, like an inter-cell beam management i.e., to support L1-L2 inter-cell mobility the UE should be configured to perform measurements on cells which are not the serving cells as defined up to Rel-17.

In Rel-17, to support inter-PCI multiple Transmission and Reception Point (mTRP) operation, a solution has been standardized where a CSI resource may be associated to a Physical Cell ID (PCI) which is not the same PCI of one of the serving cells. That solution also requires the UE to receive an explicit indication of which beams (SSBs) and PCIs to be measured for a given reporting configuration.

The goal is to o specify mechanism and procedures of L1/L2 based inter-cell mobility for mobility latency reduction:
Configuration and maintenance for multiple candidate cells to allow fast application of configurations for candidate cells [RAN2, RAN3]
Dynamic switch mechanism among candidate serving cells (including SpCell and SCell) for the potential applicable scenarios based on L1/L2 signalling [RAN2, RAN1]
L1 enhancements for inter-cell beam management, including L1 measurement and reporting, and beam indication [RAN1, RAN2]
   Note 1: Early RAN2 involvement is necessary, including the possibility of further clarifying the interaction between this bullet with the previous bullet
Timing Advance management [RAN1, RAN2]
Central Unit (CU) or Distributed Unit (DU) interface signaling to support L1/L2 mobility, if needed [RAN3]
Note 2: FR2 specific enhancements are not precluded, if any.
Note 3: The procedure of L1/L2 based inter-cell mobility are applicable to the following scenarios:
   Standalone, CA and NR-DC case with serving cell change within one CG
   Intra-DU case and intra-CU inter-DU case (applicable for Standalone and CA: no new RAN interfaces are expected)
   Both intra-frequency and inter-frequency
   Both FR1 and FR2
   Source and target cells may be synchronized or non-synchronized

### Summary

In an embodiment, a method performed by a User Equipment device (UE) configured with one or more L1/L2 inter-cell mobility candidate cells for performing Radio Link Monitoring (RLM) and Radio Link Failure (RLF) detection is provided. The method can include receiving one or more L1/L2 inter-cell mobility candidate cell configurations. The method can also include performing a plurality of RLM processes based on parameters of one or more of a serving cell configuration and one or more of the L1/L2 inter-cell mobility candidate cell configurations. The method can also include declaring an RLF on one or more of the serving cells or the one or more L1/L2 inter-cell mobility candidate cells. The method can also include performing a network operation based on a type of the RLF.

In an embodiment, a UE comprises a memory that stores computer-executable instructions and a processor that executes the computer-executable instruction to perform operations. The operations include receiving one or more L1/L2 inter-cell mobility candidate cell configurations. The operations also include performing a plurality of RLM processes based on parameters of one or more of a serving cell configuration and one or more of the L1/L2 inter-cell mobility candidate cell configurations. The operations also include declaring an RLF on one or more of the serving cells or the one or more L1/L2 inter-cell mobility candidate cells. The operations also include performing a network operation based on a type of the RLF.

In another embodiment method performed by a first network node of a serving cell for performing RLM and RLF detection is provided. The method includes receiving from a UE an indication that an RLF has been declared on an L1/L2 inter-cell mobility cell for which a configuration has been provided to the UE by the first network node. The method also includes providing to the UE a new Radio Resource Control, RRC, message, the RRC message comprising at least one of a configuration to reconfigure the L1/L2 inter-cell mobility cell, a layer 1 signaling indicating L1/L2 inter-cell mobility execution to a L1/l2 inter-cell mobility candidate cell, and an indication to remove the L1/L2 inter-cell mobility cell. The method also includes providing a message to a second network node that comprises at least one of an indication on which L1/L2 inter-cell mobility cell the RLF was declared, an indication that a layer 1 signal indicating L1/L2 inter-cell mobility execution to a L1/L2 inter-cell mobility candidate cell has been sent to the UE, and a new configuration for L1/L2 inter-cell mobility cell to be sent to the UE.

In an embodiment, provided is a first network node of a serving cell configured to perform RLM, and RLF detection, where the first network node includes a memory that stores computer-executable instructions and a processor that executes the computer-executable instruction to perform operations. The operations include receiving from a UE an indication that an RLF has been declared on an L1/L2 inter-cell mobility cell for which a configuration has been provided to the UE by the first network node. The operations also includes providing to the UE a new Radio Resource Control, RRC, message, the RRC message comprising at least one of a configuration to reconfigure the L1/L2 inter-cell mobility cell, a layer 1 signaling indicating L1/L2 inter-cell mobility execution to a L1/l2 inter-cell mobility candidate cell, and an indication to remove the L1/L2 inter-cell mobility cell. The operations also includes providing a message to a second network node that comprises at least one of an indication on which L1/L2 inter-cell mobility cell the RLF was declared, an indication that a layer 1 signal indicating L1/L2 inter-cell mobility execution to a L1/L2 inter-cell mobility candidate cell has been sent to the UE, and a new configuration for L1/L2 inter-cell mobility cell to be sent to the UE.

In another embodiment method performed by a first network node of a Central Unit (CU) cell for performing RLM and RLF detection is provided. The method includes receiving from a second network node of a serving cell or a candidate cell a message comprising at least one of an indication on which L1/L2 inter-cell mobility cell of a group of L1/L2 inter-cell mobility cells a RLF was declared by a UE, an indication that layer 1 signal indicating L1/L2 mobility execution to a L1/L2 inter-cell mobility candidate cell has been sent to the UE, and a new configuration for L1/L2 inter-cell mobility to be sent to the UE (302). The method also includes providing a message to the UE, wherein the message includes a new configuration for L1/L2 inter-cell mobility.

In an embodiment, provided is a first network node of a serving cell configured to perform RLM and RLF detection, where the first network node includes a memory that stores computer-executable instructions and a processor that executes the computer-executable instruction to perform operations. The operations include receiving from a second network node of a serving cell or a candidate cell a message comprising at least one of an indication on which L1/L2 inter-cell mobility cell of a group of L1/L2 inter-cell mobility cells a RLF was declared by a UE, an indication that layer 1 signal indicating L1/L2 mobility execution to a L1/L2 inter-cell mobility candidate cell has been sent to the UE, and a new configuration for L1/L2 inter-cell mobility to be sent to the UE (302). The operations also include providing a message to the UE, wherein the message includes a new configuration for L1/L2 inter-cell mobility.

In an embodiment, some of the advantages of the techniques disclosed herein is the possibility to detect an RLF and avoid Radio Resource Control (RRC) reestablishment on the serving cell, when the UE is configured with one or more L1/L2 inter-cell mobility candidate cells. Using these techniques, when the UE leaves the coverage of the Special Cell (SpCell) but is still in the coverage of one of the L1/L2 inter-cell mobility candidate cells, the UE would not declare RLF on the serving cell and move to candidate cell using inter-cell beam management operation. In some embodiments, another advantage is that the UE, after experiencing RLF in one or more L1/L2 inter-cell mobility candidate cells, stops performing RLM on those cells. This saves UE power as the UE does not need to perform unnecessary radio link monitoring.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of a radio link failure (RLF) according to an exemplary embodiment of the disclosure;

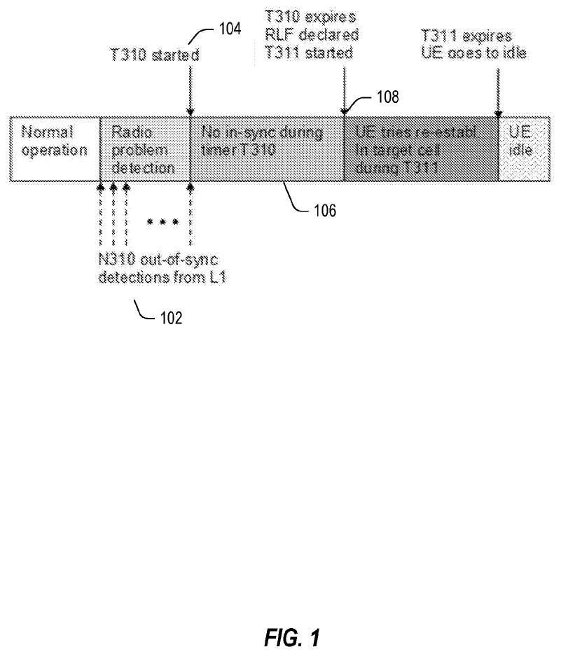

FIG. 2 shows an example of a User Equipment (UE) leaving a coverage area of an L1/L2 intercell mobility candidate cell according to an exemplary embodiment of the disclosure;

FIGS. 3A-3C depict a message sequence chart for performing Radio Link Monitoring (RLM) and RLF detection according to an exemplary embodiment of the disclosure;

FIG. 4 shows an example of a communication system 400 in accordance with some embodiments;

FIG. 5 shows a UE in accordance with some embodiments;

FIG. 6 shows a network node in accordance with some embodiments;

FIG. 7 is a block diagram of a host in accordance with some embodiments;

FIG. 8 is a block diagram illustrating a virtualization environment in which functions implemented by some embodiments may be virtualized; and

FIG. 9 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

### Initial Disclaimers

The text refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility or L1/L2 inter-cell mobility. The basic principle is that the UE receives a lower layer signaling from the network indicating to the UE a change of its serving cell (e.g., change of Primary Cell (PCell), from a source to a target PCell), wherein a lower layer signaling is a message/signaling of a lower layer protocol. A lower layer protocol refers to a lower layer protocol in the air interface protocol stack compared to Radio Resource Control (RRC) protocol, e.g. Medium Access Control (MAC) is considered a lower layer protocol as it is “below” RRC in the air interface protocol stack, and in this case a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility; in addition, it may also increase the mobility robustness as the network may respond to faster changes in the channel conditions. Another relevant aspect in L1/L2 inter-cell mobility is that in multi-beam scenario, a cell can be associated to multiple Synchronization Signal Blocks (SSB)s, and during a half-frame, different SSBs may be transmitted in different spatial directions (i.e., using different beams, spanning the coverage area of a cell). Similar reasoning may be applicable to Channel State Information Reference Signal (CSI-RS) resources, which may also be transmitted in different spatial directions. Hence, in L1/L2 inter-cell mobility, the reception of a lower layer signaling indicates the User Equipment (UE) to change from one beam in the serving cell, to another beam in a neighbor cell (which is a configured candidate cell), and by that changing serving cell.

The text refers to the term “L1/L2 inter-cell mobility candidate cell” to refer to a cell the UE is configured with when configured with L1/L2 inter-cell mobility. That is a cell the UE can move to in a L1/L2 inter-cell mobility procedure, upon reception of a lower layer signaling. These cells may also be called candidate cells, candidates, mobility candidates, non-serving cells, additional cells, etc. This is a cell the UE perform measurements on (e.g., CSI measurements) as disclosed in the present disclosure, so that the UE reports these measurements and network may take educated decision on which beam (e.g., TCI state) and/or cell the UE is to be switched to. A L1/L2 inter-cell mobility candidate cell may be a candidate to be a target PCell or Primary Secondary (PSCell), or a Secondary Cell (SCell) of a cell group (e.g., Master Cell Group (MCG) SCell).

There currently exist certain challenge(s). Radio Link Failure (RLF) detection has been defined to allow the UE to detect a failure and perform autonomous mobility (cell selection followed by an RRC Reestablishment procedure), e.g., when something does not work properly in the transmission of an RRC Measurement report from the UE to the network or in the reception of the response to that report: an RRC Reconfiguration including the Information Element (IE) Reconfiguration with Sync (handover command). This may occur, for example, when the measurement triggers are not optimally tuned.

In L1/L2 inter-cell mobility the UE is configured with one or more L1/L2 inter-cell mobility candidate cells (e.g. each associated to a physical cell identifier (PCI), such as PCI-1, PCI-2, PCI-3, PCI-4), which are the cells the UE may be indicated by the network to move to upon reception of a lower layer signaling, such as a MAC Control Element (CE) or Downlink Control Indication (DCI), indicating one of the configured L1/L2 inter-cell mobility candidate cells. However, most likely the UE will be configured with finite number of L1/L2 inter-cell mobility candidate cells, i.e., there will always be some limit or border wherein the UE reaches a cell which has not been configured as a L1/L2 inter-cell mobility candidate. In addition, because inter-cell L1/L2 inter-cell mobility is only meant to be supported for intra-CU scenarios, all candidate cells needs to be controlled by the same or different DU(s) of the same CU. So even if the UE could add candidates, it is not possible if the cell the UE is entering the coverage of (e.g., cell with PCI-x) is associated to another CU.

In this case, RRC-based mobility to the cell of PCI-x is needed. Thus, as discussed above, the fact that RRC-based mobility needs to be supported, at least in these cases the UE leaves the coverage of al configured L1/L2 inter-cell mobility candidates, an RLF mechanism is needed to detect a radio failure for a UE configured with one or more L1/L2 inter-cell mobility candidate(s) is needed, as the RRC measurement reporting framework may not always work.

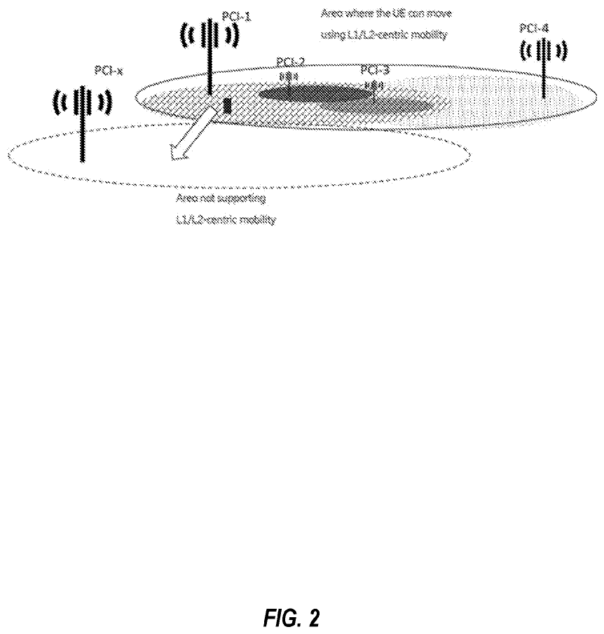

FIG. 2 depicts a scenario showing a UE leaving the coverage area of L1/L2 inter-cell mobility candidate cells to an area that does not support L1/L2-centric mobility.

The existing solution for RLF detection in 5G NR due to radio related problems rely on a RLM process based on the monitoring of the Special Cell (SpCell), such as the PCell in the Master Cell Group (MCG), or the PSCell in the Secondary Cell Group (SCG). However, in L1/L2 inter-cell mobility the UE is not only configured with an SpCell, but in addition, with one or more L1/L2 inter-cell mobility candidates which the UE can move to with L1/L2 inter-cell mobility execution. Hence, the existing framework for RLF detection and RLM may not be suitable, as the UE may actually leave the coverage of the SpCell it connects in the transitions to RRC_CONNECTED, but still be in the coverage of one of the L1/L2 inter-cell mobility candidate cells, i.e. in the existing solution the UE would declare RLF even though it is still in the coverage in which it is capable of moving using inter-cell beam management operations. These undesirable (and unnecessary) RLFs and RRC Re-establishment procedures, which degrades the Key Performance Indicators at the network side, increases the signaling, reduces the control at the network side for L1/L2 inter-cell mobility.

Certain aspects of the disclosure and their embodiments may provide solutions to these or other challenges. The present disclosure comprises methods at a User Equipment (UE) configured with one or more L1/L2 inter-cell mobility candidate cell(s) for performing Radio Link Monitoring (RLM) and RLF detection, the method comprising:
Receiving one or more L1/L2 inter-cell mobility candidate cell configuration(s);
Performing multiple RLM processes based parameter(s) on one or more of:
   A serving cell configuration; and
   One or more L1/L2 inter-cell mobility candidate cell configuration(s);
Declaring a RLF on one or more of:
   A serving cell; and
   One or more L1/L2 inter-cell mobility candidate cell(s);
Initiating at least one of the following procedures:
   Triggering RRC re-establishment procedure, if RLF is declared on:
      The serving cell; or
      All the L1/L2 inter-cell mobility candidate cell(s);
   Sending a report to a network node, if RLF is declared only on at least one of the L1/L2 inter-cell mobility candidate cell(s).

The present disclosure comprises methods at a source network node (e.g., Serving DU or Candidate DU) wherein these methods comprise:
A configuration to reconfigure (add/mode/release) the failed L1/L2 inter-cell mobility cell;
A lower layer signaling indicating L1/L2 inter-cell mobility execution to a L1/L2 inter-cell mobility candidate cell;
An indication to remove the failed L1/L2 inter-cell mobility cell;
   If the failed L1/L2 inter-cell mobility cell is the serving cell the indication may further comprise a lower layer signaling indicating L1/L2 inter-cell mobility execution to a L1/L2 inter-cell mobility candidate cell.
Sending a message to a third network node (e.g., a Central Unit—CU), wherein such message may comprise one or more of the following:
   An indication on which L1/L2 inter-cell mobility cell (i.e., either the serving cell or one or more of the a L1/L2 inter-cell mobility candidate cell(s).
   An indication that a lower layer signaling indicating L1/L2 inter-cell mobility execution to a L1/L2 inter-cell mobility candidate cell has been sent to the UE
   A new configuration for L1/L2 inter-cell mobility to be sent to the UE and wherein this new configuration may further comprise:
      A configuration to reconfigure (add/mode/release) the failed L1/L2 inter-cell mobility cell

The present disclosure comprises methods at a source network node (e.g., Serving DU or Candidate DU) wherein these methods comprise:
Receiving a message from a source network node (e.g., a Serving DU or a Candidate DU), wherein such message may comprise one or more of the following:
   An indication on which L1/L2 inter-cell mobility cell (i.e., either the serving cell or one or more of the a L1/L2 inter-cell mobility candidate cell(s).
   An indication that a lower layer signaling indicating L1/L2 inter-cell mobility execution to a L1/L2 inter-cell mobility candidate cell has been sent to the UE
   A new configuration for L1/L2 inter-cell mobility to be sent to the UE and wherein this new configuration may further comprise:
      A configuration to reconfigure (add/mode/release) the failed L1/L2 inter-cell mobility cell
Sending a message to the UE, wherein the message include a new configuration for L1/L2 inter-cell based mobility.

A UE, configured with a serving cell and one or more L1/L2 inter-cell mobility candidate cells, performs multiple RLM processes and, while performing RLM, the UE detect RLF independently on the serving cell and in one or more L1/L2 inter-cell mobility candidate cells.

This means that the UE performs multiple RLM process based on parameters of a serving cell and parameter(s) of at least one L1/L2 inter-cell mobility candidate cell (called in the document joint RLM), when it receives a lower layer signaling indicating L1/L2 inter-cell mobility execution to the L1/L2 inter-cell mobility candidate cell, without updating the RLM process.

Further, based on which cell the RLF is detected the UE may initiate different procedure and in the present disclosure there can be the following exemplary embodiments:
Action 1) The UE initiate the RRC re-establishment procedure if the RLF is declared either on the serving cell or in all the one L1/L2 inter-cell mobility candidate cell(s).
Action 2) The UE sends a report to a network node in case the RLF is declared on one or more of the L1/L2 inter-cell mobility candidate cell(s) but not on the serving cell and not on all the L1/L2 inter-cell mobility candidate cell(s).

Certain embodiments may provide one or more of the following technical advantage(s). One of the advantages of the methods and techniques disclosed herein is the possibility to detect a RLF and avoid RRC reestablishment on the serving cell, when the UE is configured with one or more L1/L2 inter-cell mobility candidate cells. Using this solution, when the UE leaves the coverage of the SpCell but is still in the coverage of one of the L1/L2 inter-cell mobility candidate cells, the UE would not declare RLF on the serving cell and move to candidate cell using inter-cell beam management operation.

In some embodiments, an advantage is that the UE, after experiencing RLF in one or more L1/L2 inter-cell mobility candidate cells, it stops performing RLM on those cells. This saves UE power as the UE does not need to perform unnecessary radio link monitoring.

### Further Details

In one set of embodiments, a serving cell corresponds to a cell whose serving cell configuration has a Transmission Configuration Indicator (TCI) state which is activated. That may be a serving cell the UE is configured with when the UE transition to RRC_CONNECTED, or a cell the UE moves to with an RRC Reconfiguration with sync procedure (or handover) or a cell the UE moves to with a L1/L2 inter-cell mobility execution.

In one set of embodiments, a L1/L2 inter-cell mobility candidate cell is a cell the UE is configured with for L1/L2 inter-cell mobility, i.e., after the configuration, the UE may receive a lower layer signaling (e.g., MAC CE or DCI) indicating the execution of L1/L2 inter-cell mobility to that configured cell. In one option that may be called a serving cell, though that is not “activated” if the UE does not have an activated TCI state of that cell. In one option that is not called a serving cell, but simply a candidate or non-serving cell the UE is configured with for L1/L2 inter-cell mobility.

In one set of embodiments, when a L1/L2 inter-cell mobility candidate cell is configured at the UE by a source network node (e.g., the Candidate Distributed Unit (DU)), the configuration may include an indication on whether the UE should initiate the RRC re-establishment procedure when an RLF is detected only the serving cell or when the RLF is detected on the serving cell and all the L1/L2 inter-cell mobility candidate cell(s) for which RLM is configured. This basically means that the Candidate DU can decide to indicate in the configuration for a L1/L2 inter-cell mobility candidate cell whether the UE should send a report if RLF is triggered in this L1/L2 inter-cell mobility candidate cell or not. Of course if the Candidate DU decides that no report is needed if an RLF is detected, the UE will pursue no actions and will trigger the RRC re-establishment procedure only when an RLF is detected on the serving cell.

In one set of embodiments, is a third network node (e.g., a Central Unit—(CU)) that decide on whether the UE should initiate the RRC re-establishment procedure when an RLF is detected only the serving cell or when the RLF is detected on the serving cell and all the L1/L2 inter-cell mobility candidate cell(s). This means that when receiving the RRC message by the third network node with a configuration for a L1/L2 inter-cell mobility candidate cell, the RRC message may further comprise an indication on whether the UE should initiate the RRC re-establishment procedure when an RLF is detected only the serving cell or when the RLF is detected on the serving cell and all the L1/L2 inter-cell mobility candidate cell(s).

### UE Methods

The UE performs multiple RLM processes (one for each cell) based on RLM parameter(s) of the serving cell and RLM parameter(s) of each L1/L2 inter-cell mobility candidate cell.
(Handling of RLM-RSs) In a set of embodiments, the UE performs an RLM process by monitoring a first set of RLM-RS(s) of the serving cell, and, at the same time, the UE monitors a second set of RLM-RS(s) of the target candidate cell. This means that the UE perform multiple RLM processes at the same time for the serving cell and for each L1/L2 inter-cell mobility candidate cell.
   (implicit RLM) In one embodiment, the first set of RLM-RS(s) of the serving cell comprises one or more beams which are being used for the transmissions in the serving cell of control (e.g., PDCCH) and data channels, e.g. PDSCH.
   (implicit RLM) In one embodiment, the first RLM-RS(s) of the serving cell comprises one or more SSBs and/or CSI-RSs configured as QCL source of the currently activated TCI state(s) of the serving cell, e.g. unified TCI state (as defined in TS 38.213, or PDCCH TCI state).
   (implicit RLM) In one embodiment, the second set of RLM-RS(s) of the target candidate cell comprises one or more beams which are being indicate for the transmissions of control (e.g., PDCCH) and data channels, e.g. PDSCH in the target candidate cell, e.g., in case the lower layer signaling for the L1/L2 inter-cell mobility execution is received for this target candidate cell.
   (implicit RLM) In one embodiment, the second set of RLM-RS(s) of the target candidate cell comprises one or more SSBs and/or CSI-RS configured as QCL source of the TCI state(s) of the target candidate cell.
   (explicit RLM) In one embodiment, the first set of RLM-RS(s) of the serving cell comprises one or more beams configured in the serving cell configuration, e.g. as part of a BWP configuration.
   (explicit RLM) In one embodiment, the first set of RLM-RS(s) of the serving cell comprises one or more SSBs and/or CSI-RS configured in the serving cell configuration, e.g. as part of a BWP configuration.
   (explicit RLM) In one embodiment, the second set of RLM-RS(s) of the target candidate cell comprises one or more beams configured for RLM in the target candidate cell configuration of the cell.
   (explicit RLM) In one embodiment, the second set of RLM-RS(s) of the target candidate cell comprises one or more SSBs and/or CSI-RSs configured for RLM in the target candidate cell configuration.
(Generating Out of Sync (OOS) indications/events on the serving cell) In a set of embodiments, the UE (e.g., the lower layers at the UE) generates an OOS indication for the serving cell if all RLM-RS(s) in the first set of RLM-RS(s) of the serving cell are worse than a configured threshold, e.g. mapped a Block Error Rate of a control channel.
(Generating Out of Sync (OOS) indications/events on the candidate cell) In a set of embodiments, the UE (e.g., the lower layers at the UE) generates an OOS indication for a candidate cell if all RLM-RS(s) in the second set of RLM-RS(s) of the candidate cell are worse than a configured threshold, e.g. mapped a Block Error Rate of a control channel.
(UE counts separate OOS indications/events for each cell) In a set of embodiments, the UE has an RLM process for each cell (i.e., the serving cell plus each candidate target cells). This means that the UE keep in its memory a set of RLF timers and counters one for each candidate target cell and one for the serving cell. This RLF timers and counters run independently on the serving cell and each candidate cell and thus also the RLF may be detected and declared independently on the serving cell and each candidate target cell.
(Keep running RLF timers) In a set of embodiments, when an RLF timer (e.g., T310, as defined in TS 38.331) expires for a cell configured with L1/L2 inter-cell based mobility (e.g., the serving cell or one of the candidate target cells), the UE does not stop the other RLF timers (e.g., T310, as defined in TS 38.331) of the other cells configured with L1/L2 inter-cell based mobility, if running.
(Keep state of RLF counters) In a set of embodiments, when the UE reaches the maximum value of a RLF related counter (e.g., N310, as defined in TS 38.331) for a cell configured for L1/L2 inter-cell based mobility (e.g., the serving cell or one of the candidate target cells), the UE keeps the state of the other RLF related counters, such as N310 and/or N311. This means that the UE will increment or reset the current values of the RLF related counters on the other cells according to the in-sync or out-of-sync indication from lower layer independently for each cell.
(Detection of L1/L2 inter-cell mobility failure) In a set of embodiments, when the UE receives a lower layer signaling indicating L1/L2 inter-cell mobility execution to a L1/L2 inter-cell mobility candidate cell, the UE starts a time Txxx and sends a message (e.g., MAC CE or Scheduling request) to the indicated L1/L2 inter-cell mobility candidate cell. If the UE receives a response message (e.g., a HARQ feedback, another form of acknowledgement and/or a response message) while the timer is running, the UE stops the timer and considers the process successful; Else, if the timer expires, the UE considers the L1/L2 inter-cell mobility as a failed procedure. Notice that the failure handling mechanisms is useful in this case as RLM stops in the serving cell and, while the timer is running, it is not started. In other words, RLM would only re-start, according to the configuration of the target candidate cell, after the UE receives the response from the network, after the L1/L2 inter-cell mobility execution.

UE actions upon detecting of an RLF on the serving cell or on one or more of the L1/L2 inter-cell mobility candidate cell(s):
(Re-establishment only if RLF on the serving cell—1a) If the UE declared RLF at the serving cell, according to a method in the document, the UE initiates an RRC Re-establishment procedure. This means that if the UE cannot communicate anymore with the serving cell, it will re-establish the RRC connection regardless of one or more of the L1/L2 inter-cell mobility candidate cell(s) are in good condition or not.
(Re-establishment if RLF all cells configured for L1/L2 inter-cell mobility—1b) According to a method in the document, the UE initiates an RRC Re-establishment procedure only when declaring RLF at the serving cell and at all the L1/L2 inter-cell mobility candidate cell(s). This means that the UE does not have any cell available to which recover the connection.
(Re-establishment if RLF on “K” cells configured for L1/L2 inter-cell mobility—1c) According to a method in the document, the UE initiates an RRC Re-establishment procedure only when declaring RLF on “K” cells configured with L1/L2 inter-cell mobility candidate cell(s). In this case “K” includes the serving cell plus K−1 L1/L2 inter-cell mobility candidate cell(s).
(Re-establishment if RLF on MCG—1d) If the UE declared RLF at a Master Cell Group (MCG), according to a method in the document, the UE initiates an RRC Re-establishment procedure. An RLF at the MCG, or M-RLF, means that the UE is monitoring a PCell as the Special Cell.
(Report if RLF on one candidate cell but not on serving cell—2a) If the UE declared RLF on one or more of the L1/L2 inter-cell mobility candidate cell(s) but not on the serving cell, according to a method in the document, the UE sends a message to the source network node (e.g., the Serving DU or serving CU) to inform about the declared RLF on one or more of the L1/L2 inter-cell mobility candidate cell(s).
(Report if RLF on one candidate cell but not on serving cell—2b) If the UE declared RLF on one or more of the L1/L2 inter-cell mobility candidate cell(s) but not on the serving cell, according to a method in the document, the UE sends a message to the source network node (i.e., the Serving DU) to inform about the declared RLF on one or more of the L1/L2 inter-cell mobility candidate cell(s).
(Report if at least no RLF on one cell—2c) If the UE declared RLF on multiple L1/L2 inter-cell mobility cell(s) but there is at least one cell on which the RLF has not detected, according to a method in the document, the UE sends a message over the network node that is hosting the cell in which the RLF has not been declared (e.g., the Serving DU or Candidate DU) to inform about the declared RLF.
(Report if RLF on SCG—2d) If the UE declared RLF at a Secondary Cell Group (SCG), according to a method in the document, the UE initiates an SCG Failure Report procedure, e.g. to the network node operating as Master Node for a UE ins Multi-Radio Dual Connectivity (MR-DC). An RLF at the SCG, or S-RLF, means that the UE is monitoring a PSCell (Special cell of the SCG) as the Special Cell.
(Autonomous execution of L1/L2 inter-cell mobility by the UE) If the UE experience RLF on the serving cell and one or more L1/L2 inter-cell mobility candidate cell(s), if there is at least one L1/L2 inter-cell mobility candidate cell(s) in which the RLF has not been declared, the UE may decide to execute the L1/L2 inter-cell based mobility serving cell change procedure to one of the non-failed L1/L2 inter-cell mobility candidate cell(s). In one example, after the UE has experienced RLF on the serving cell and one or more L1/L2 inter-cell mobility candidate cell(s), it performs cell selection. If the selected cell is an L1/L2 inter-cell mobility candidate cell(s), the UE decides to execute the L1/L2 inter-cell based mobility serving cell change procedure to the selected cell. In one example, the UE decides to execute the L1/L2 inter-cell based mobility serving cell change procedure to the selected cell if the selected cell is an L1/L2 inter-cell mobility candidate cell(s) in which the RLF has not been declared. In one example, the UE selects a cell based on the lower-layer measurements performed on the L1/L2 inter-cell mobility candidate cell(s), for example, selecting the cell with the highest ranked measurement value. In one example, the UE uses an indication, received from the network, whether to execute the L1/L2 inter-cell based mobility serving cell change procedure to the selected cell. In one example, this indication is configured for each L1/L2 inter-cell mobility candidate cell, such as a field part of an RRC configuration of each L1/L2 inter-cell mobility candidate cell. This field indicates whether the UE is supposed to execute the L1/L2 inter-cell based mobility serving cell change procedure to the particular L1/L2 inter-cell mobility candidate cell after experiencing RLF. In one example, the UE takes this indication into account during cell selection, for example, by excluding any cells from the cell selection with an indication that the UE is not supposed to execute the L1/L2 inter-cell based mobility serving cell change procedure to the particular L1/L2 inter-cell mobility candidate cell after experiencing RLF.
(Further possible actions if RLF is detected on one or more L1/L2 inter-cell mobility candidate cell(s)). If the If the UE experience RLF on one or more L1/L2 inter-cell mobility candidate cell(s), the UE sends a message over the serving cell for informing that one or more L1/L2 inter-cell mobility candidate cell(s) has failed and, at the same time, stop performing RLM on that cell until a new (RLM) configuration is received for the failed L1/L2 inter-cell mobility candidate cell.

Content of the report sent by the UE to the source network node when an RLF is detected:
In a set of embodiments, if there is at least one cell in which the RLF has NOT been declared, the UE sends a RRC message to the source network node (e.g., the Serving DU or Candidate DU) wherein this RRC message may include one or more of the following:
   A RLF report for indicating that an RLF has been declared and wherein the report further comprising:
      Whether the RLF has been declared on the serving cell or on one or more L1/L2 inter-cell mobility candidate cell(s).
      The TCI state ID (or a list of TCI state IDs) of the serving cell or the L1/L2 inter-cell mobility candidate cell(s) on which the RLF has been detected.
      The beam ID (or a list of beam IDs) of the serving cell or the L1/L2 inter-cell mobility candidate cell(s) on which the RLF has been detected.
      The latest L1 measurement (e.g., CSI measurements) available on the serving cell and one or more L1/L2 inter-cell mobility candidate cell(s).
      The latest L3 measurement available on the serving cell and one or more L1/L2 inter-cell mobility candidate cell(s).
      A suggested TCI state ID for which receiving a lower layer signaling indicating L1/L2 inter-cell mobility execution.
      A cause value describing why the RLF has been declared. The cause value can be common or one for each cell in which the RLF has been declared.
      An indication that a L1/L2 inter-cell mobility execution has been performed autonomously by the UE on the cell with a certain TCI state ID, beam ID, serving cell ID.

In one set of embodiments, the UE performs RLM on a subset of the L1/L2 inter-cell mobility candidate cell(s). In one example, the UE only performs RLM on those L1/L2 inter-cell mobility candidate cell(s) for which it has received an RLM configuration. In another example, the UE receives an indication to start, stop or resume the RLM for L1/L2 inter-cell mobility candidate cell(s). In one example, this received indication is a MAC CE. In this way, the network is able to control on which L1/L2 inter-cell mobility candidate cell(s) the UE performs RLM. For example, the UE may perform RLM on only the L1/L2 inter-cell mobility candidate cell(s) that satisfies a certain criterion, e.g. those cells for which received measurement report quantity fulfil a certain condition, e.g. is above a certain threshold or the N best cells. This saves UE power as the UE do not need to perform RLM on cells which may be less likely as target cells during L1/L2 mobility.

### Network Methods

Upon detecting RLF, the UE may send an RRC message including a report to a network node (e.g., the Serving DU or Candidate DU) in order to inform that one or multiple RLF have been detected.
In a set of embodiments, upon receiving an RRC message from the UE that include a report to indicate that one or multiple RLF have been declared on one or more L1/L2 inter-cell mobility cell(s), the network node (e.g., the Serving DU, Candidate DU, or CU) may decide to perform one or more of the following actions:
   Determine a new configuration for the cell (the Serving DU for the serving cell or the Candidate DU for one or more of the L1/L2 inter-cell mobility candidate cell(s)) in which the RLF has been declared and wherein this configuration comprises one or more of the following:
      An indication on whether the cell needs to be released or modified.
         If the cell needs to be modified the indication further include a new configuration to be applied by the UE for this cell
      A configuration to add a new L1/L2 inter-cell mobility candidate cell.
         The configuration may further comprise a lower layer signaling indicating L1/L2 inter-cell mobility execution to this cell.
         The configuration may further comprise a lower layer signaling indicating L1/L2 inter-cell mobility execution to another cell (where the RLF has not been declared).
   Sending a lower layer signaling indicating L1/L2 inter-cell mobility execution to one or the L1/L2 inter-cell mobility candidate cell(s).
   Sending an indication in order to deconfigure/deactivate/remove L1/L2 inter-cell mobility at the UE

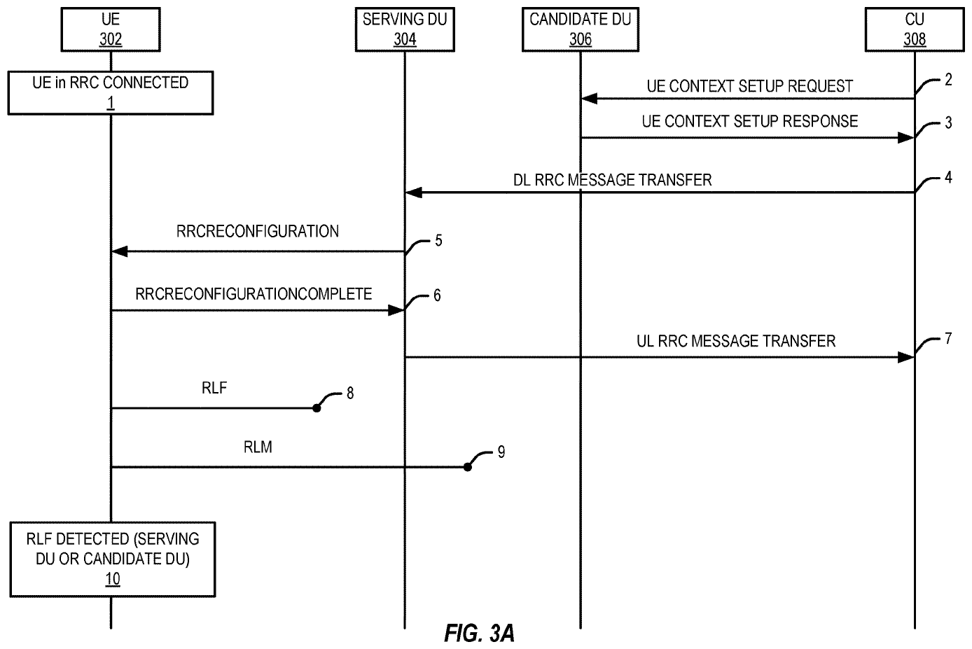

FIGS. 3A, 3B, and 3C depicts a message sequence chart associated with the above described methods. FIGS. 3A, 3B, and 3C depict a single message sequence chart that has been split across three pages for ease of viewing. The messages in the message sequence chart are passed between a UE 302, a Serving DU or serving cell 304, a candidate DU or candidate cell 306, and a CU 308. At step 1, the UE 302 is an RRC_Connected state where an RRC connection is established between the UE 302 and the serving cell 304, and the network configures the UE 302 with all the parameters to facilitate communications between them.

At step 2, the CU 308 passes to the candidate cell 306 a UE context setup request for configuring L1/L2 inter-cell mobility.

At step 3, the candidate cell 306 sends a UE Context Setup Response confirming the configuration target candidate cell of L1/L2 inter-cell mobility.

At step 4, the CU 308 sends a Downlink RRC Message Transfer message to serving cell 304 which comprises the configuration for L1/L2 inter-cell mobility candidates.

At step 5, the serving cell 304 provides to the UE 302 RRCReconfiguration for L1/L2 inter-cell mobility candidates.

At step 6 the UE 302 acknowledges that the RRCReconfiguration is complete.

At step 7, the serving cell transfers the RRC message to the CU 308.

At step 8, the UE experiences an RFL with the serving cell 304, and at step 9 the UE experiences an RFL with one of or all of the candidate cells 306.

At step 10, the RLF is determined by the UE 302 in response to performing a plurality of RLM processes, including monitoring a first set of RLM-RS(s) of the serving cell 304, and, at the same time, the UE 302 monitors a second set of RLM-RS(s) of the target candidate cell 306.

At step 11 or 17, the UE 302 performs one of two alternate processes, depending on where the RLF was declared.

At step 11, the UE 302 sends an RRC message with RLF indication to serving cell 304, and serving cell 304 sends, at step 13 the F1AP message with the RLF indication to the CU 308. The CU 308 provides, at 14 the F1AP message with RLF indication to one or more of the candidate cells 306, which reply at 15 with the new L1/L2 configuration to add/remove/modify candidate cell, and then the CU passes to the serving cell 304 a DL RRC message with the configuration information.

In the alternate step 17, at 18 the UE 302 provides the RLF indication to one or more of the candidate cells 306, which message the CU 308 with the RLF indication AND the new L1/L2 configuration at 19, and 20 send to the CU 308 a F1Ap message with the new L1/L2 configuration. Then the CU 308 at 21 passes to the serving cell 304 a DL RRC message with the configuration information for L1/L2 inter-cell mobility candidates.

At step 22, the serving cell configurations the UE 302 with the configurations for L1/L2 inter-cell mobility candidates at step 23, the UE 302 reports the configuration is complete. At step 24, the serving cell 304 creates a lower layer (e.g., layer 1, Physical Layer) signal for triggering the L1/L2 intercell mobility.

At step 25, the serving cell 304 provides the lower layer signaling to the UE 302 (e.g., MAC CE, DCI, etc.). At step 26, the UE 302 adjusts the UL synchronization with target candidate cell, and at 27, the UE 302 sends an UL message to the target candidate cell 306 using TCI state ID=Y.

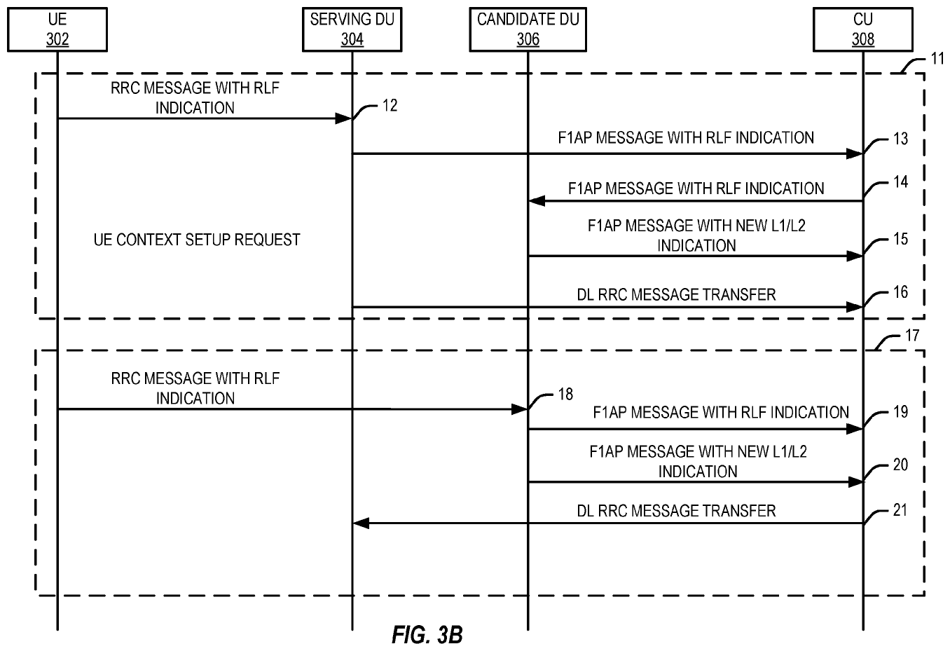

FIG. 4 shows an example of a communication system 400 in accordance with some embodiments.

In the example, the communication system 400 includes a telecommunication network 402 that includes an access network 404, such as a Radio Access Network (RAN), and a core network 406, which includes one or more core network nodes 408. The access network 404 includes one or more access network nodes, such as network nodes 410A and 410B (one or more of which may be generally referred to as network nodes 410), or any other similar Third Generation Partnership Project (3GPP) access node or non-3GPP Access Point (AP). The network nodes 410 facilitate direct or indirect connection of User Equipment (UE), such as by connecting UEs 412A, 412B, 412C, and 412D (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system 400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 402 is a cellular network that implements 3GPP standardized features. Accordingly, the telecommunication network 402 may support network slicing to provide different logical networks to different devices that are connected to the telecommunication network 402. For example, the telecommunication network 402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR—Dual Connectivity (EN-DC).

In the example, a hub 414 communicates with the access network 404 to facilitate indirect communication between one or more UEs (e.g., UE 412C and/or 412D) and network nodes (e.g., network node 410B). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a Virtual Reality (VR) headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410B. The hub 414 may also allow for a different communication scheme and/or schedule between the hub 414 and UEs (e.g., UE 412C and/or 412D), and between the hub 414 and the core network 406. In other examples, the hub 414 is connected to the core network 406 and/or one or more UEs via a wired connection. Moreover, the hub 414 may be configured to connect to a Machine-to-Machine (M2M) service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410B. In other embodiments, the hub 414 may be a non-dedicated hub—that is, a device which is capable of operating to route communications between the UEs and the network node 410B, but which is additionally capable of operating as a communication start and/or end point for certain data channels.

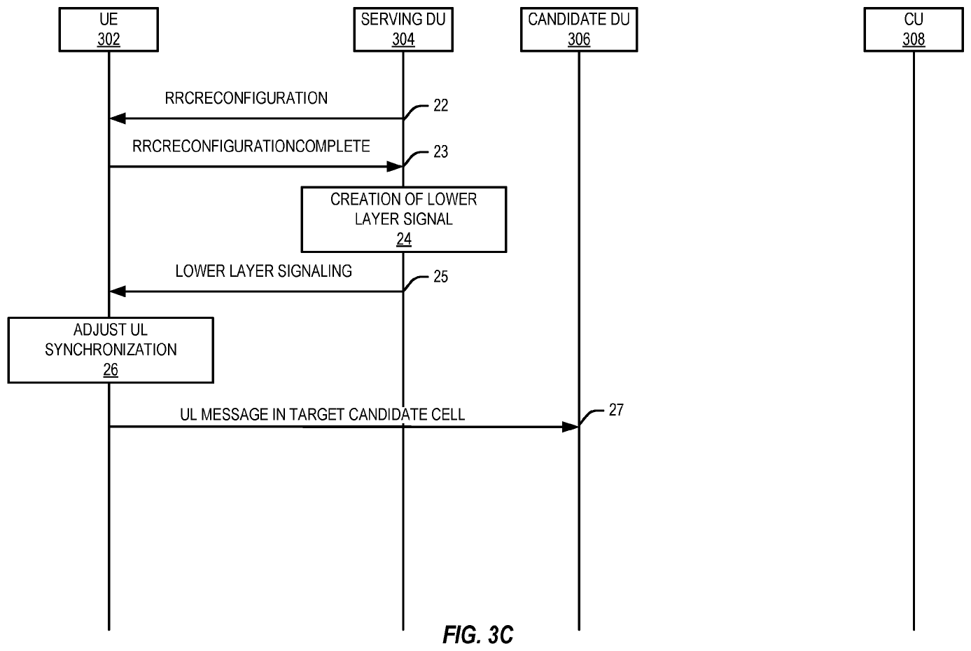

FIG. 5 shows a UE 500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 502 may include multiple Central Processing Units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging the power source 508. Power circuitry may perform any formatting, converting, or other modification to the power from the power source 508 to make the power suitable for the respective components of the UE 500 to which power is supplied.

The memory 510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 510 may allow the UE 500 to access instructions, application programs, and the like stored on transitory or non-transitory memory media, to off-load data, or to upload data. An article of manufacture, such as one utilizing a communication system, may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., the antenna 522) and may share circuit components, software, or firmware, or alternatively be implemented separately.

In the illustrated embodiment, communication functions of the communication interface 512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

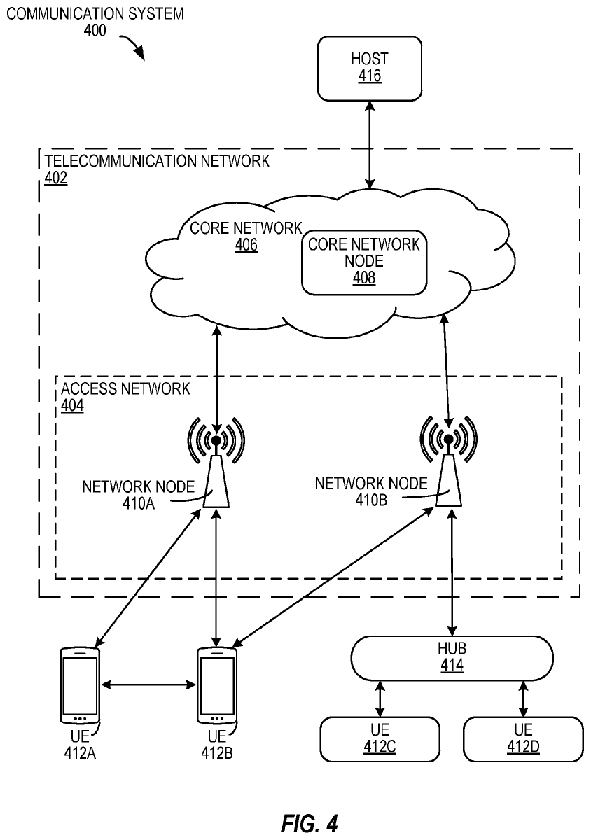

FIG. 6 shows a network node 600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes processing circuitry 602, memory 604, a communication interface 606, and a power source 608. The network node 600 may be composed of multiple physically separate components (e.g., a Node B component and an RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 600 may be configured to support multiple RATs. In such embodiments, some components may be duplicated (e.g., separate memory 604 for different RATs) and some components may be reused (e.g., an antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 600.

The processing circuitry 602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 600 components, such as the memory 604, to provide network node 600 functionality.

In some embodiments, the processing circuitry 602 includes a System on a Chip (SOC). In some embodiments, the processing circuitry 602 includes one or more of Radio Frequency (RF) transceiver circuitry 612 and baseband processing circuitry 614. In some embodiments, the RF transceiver circuitry 612 and the baseband processing circuitry 614 may be on separate chips (or sets of chips), boards, or units, such as radio units and digital units. In alternative embodiments, part or all of the RF transceiver circuitry 612 and the baseband processing circuitry 614 may be on the same chip or set of chips, boards, or units.

The memory 604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and the memory 604 are integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. The radio front-end circuitry 618 comprises filters 620 and amplifiers 622. The radio front-end circuitry 618 may be connected to the antenna 610 and the processing circuitry 602. The radio front-end circuitry 618 may be configured to condition signals communicated between the antenna 610 and the processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of the filters 620 and/or the amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface 606 may comprise different components and/or different combinations of components.

In certain alternative embodiments, the network node 600 does not include separate radio front-end circuitry 618; instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes the one or more ports or terminals 616, the radio front-end circuitry 618, and the RF transceiver circuitry 612 as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, the communication interface 606, and/or the processing circuitry 602 may be configured to perform any receiving operations and/or certain obtaining operations described herein as being performed by the network node 600. Any information, data, and/or signals may be received from a UE, another network node, and/or any other network equipment. Similarly, the antenna 610, the communication interface 606, and/or the processing circuitry 602 may be configured to perform any transmitting operations described herein as being performed by the network node 600. Any information, data, and/or signals may be transmitted to a UE, another network node, and/or any other network equipment.

The power source 608 provides power to the various components of the network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid or an electricity outlet) via input circuitry or an interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

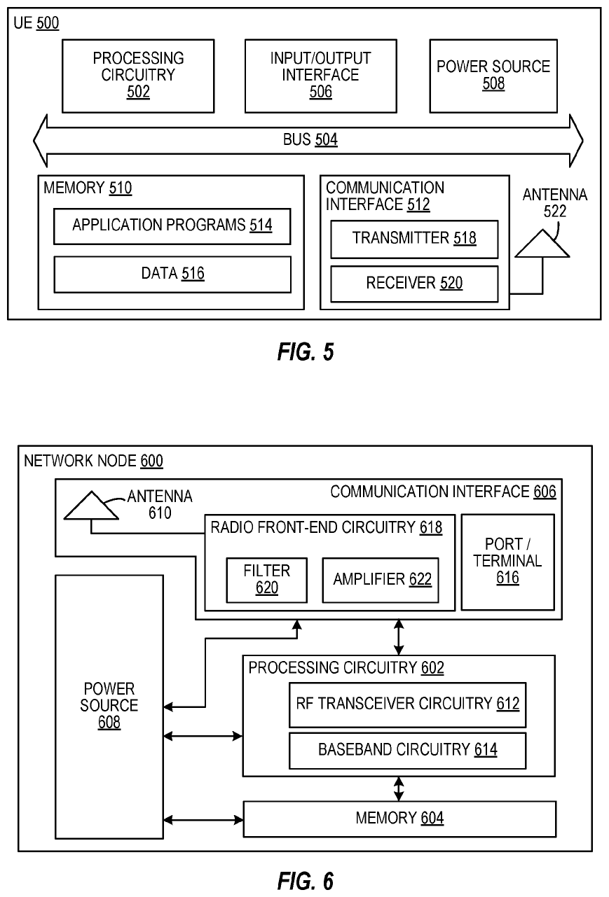

FIG. 7 is a block diagram of a host 700, which may be an embodiment of the host 416 of FIG. 4, in accordance with various aspects described herein. As used herein, the host 700 may be or comprise various combinations of hardware and/or software including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and memory 712. Other components may be included in other embodiments. Features of these components may be substantially similar to those described with respect to the devices of previous figures, such as FIGS. 5 and 6, such that the descriptions thereof are generally applicable to the corresponding components of the host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 714 may also provide for user authentication and licensing checks and may periodically report health, routes, and content availability to a central node, such as a device in or on the edge of a core network. Accordingly, the host 700 may select and/or indicate a different host for Over-The-Top (OTT) services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

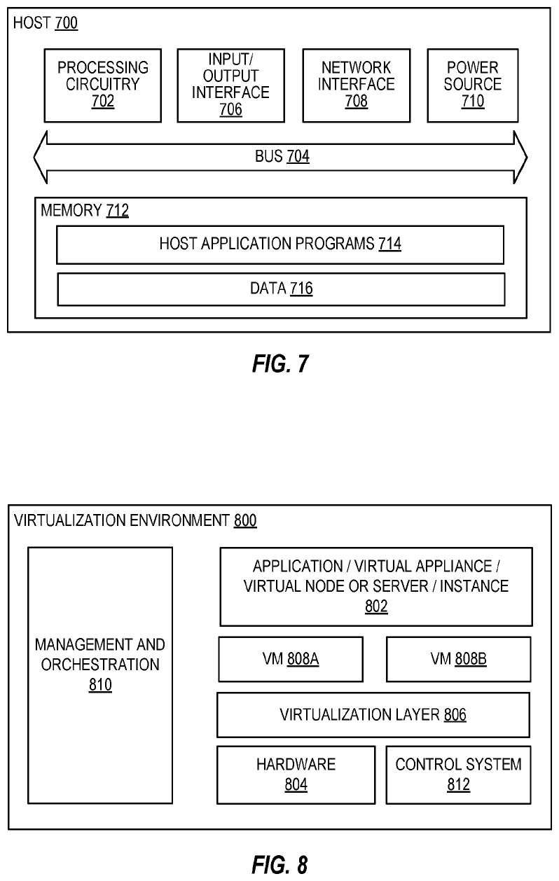

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or VM Monitors (VMMs)), provide VMs 808A and 808B (one or more of which may be generally referred to as VMs 808), and/or perform any of the functions, features, and/or benefits described in relation with some embodiments described herein. The virtualization layer 806 may present a virtual operating platform that appears like networking hardware to the VMs 808.

The VMs 808 comprise virtual processing, virtual memory, virtual networking, or interface and virtual storage, and may be run by a corresponding virtualization layer 806. Different embodiments of the instance of a virtual appliance 802 may be implemented on one or more of the VMs 808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 808 may be a software implementation of a physical machine that runs programs as if they were executing on a physical, non-virtualized machine. Each of the VMs 808, and that part of the hardware 804 that executes that VM, be it hardware dedicated to that VM and/or hardware shared by that VM with others of the VMs 808, forms separate virtual network elements. Still in the context of NFV, a virtual network function is responsible for handling specific network functions that run in one or more VMs 808 on top of the hardware 804 and corresponds to the application 802.

The hardware 804 may be implemented in a standalone network node with generic or specific components. The hardware 804 may implement some functions via virtualization. Alternatively, the hardware 804 may be part of a larger cluster of hardware (e.g., such as in a data center or CPE) where many hardware nodes work together and are managed via management and orchestration 810, which, among others, oversees lifecycle management of the applications 802. In some embodiments, the hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 812 which may alternatively be used for communication between hardware nodes and radio units.

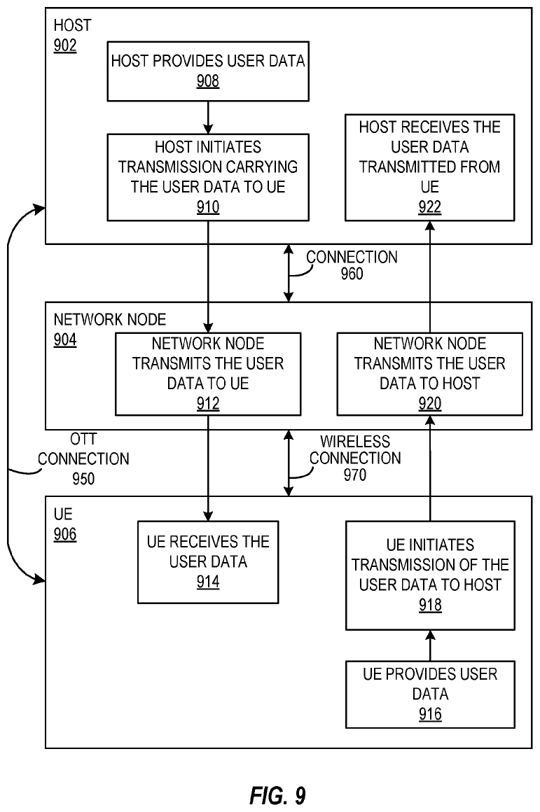

FIG. 9 shows a communication diagram of a host 902 communicating via a network node 904 with a UE 906 over a partially wireless connection in accordance with some embodiments. Example implementations, in accordance with various embodiments, of the UE (such as the UE 412A of FIG. 4 and/or the UE 500 of FIG. 5), the network node (such as the network node 410A of FIG. 4 and/or the network node 600 of FIG. 6), and the host (such as the host 416 of FIG. 4 and/or the host 700 of FIG. 7) discussed in the preceding paragraphs will now be described with reference to FIG. 9.

Like the host 700, embodiments of the host 902 include hardware, such as a communication interface, processing circuitry, and memory. The host 902 also includes software, which is stored in or is accessible by the host 902 and executable by the processing circuitry. The software includes a host application that may be operable to provide a service to a remote user, such as the UE 906 connecting via an OTT connection 950 extending between the UE 906 and the host 902. In providing the service to the remote user, a host application may provide user data which is transmitted using the OTT connection 950.

The network node 904 includes hardware enabling it to communicate with the host 902 and the UE 906 via a connection 960. The connection 960 may be direct or pass through a core network (like the core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by the UE 906 and executable by the UE's processing circuitry. The software includes a client application, such as a web browser or operator-specific “app” that may be operable to provide a service to a human or non-human user via the UE 906 with the support of the host 902. In the host 902, an executing host application may communicate with the executing client application via the OTT connection 950 terminating at the UE 906 and the host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via the connection 960 between the host 902 and the network node 904 and via a wireless connection 970 between the network node 904 and the UE 906 to provide the connection between the host 902 and the UE 906. The connection 960 and the wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904 in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve the.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR, or AR which it can broadcast, multicast, or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 950 between the host 902 and the UE 906 in response to variations in the measurement results. The measurement procedure and/or the network functionality for reconfiguring the OTT connection 950 may be implemented in software and hardware of the host 902 and/or the UE 906. In some embodiments, sensors (not shown) may be deployed in or in association with other devices through which the OTT connection 950 passes; the sensors may participate in the measurement procedure by supplying values of the monitored quantities exemplified above, or by supplying values of other physical quantities from which software may compute or estimate the monitored quantities. The reconfiguring of the OTT connection 950 may include message format, retransmission settings, preferred routing, etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency, and the like by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

Embodiment 1: A method performed by a User Equipment device, UE, (302) configured with one or more L1/L2 inter-cell mobility candidate cells (306) for performing Radio Link Monitoring, RLM, and Radio Link Failure, RLF, detection, the method comprising: receiving (FIG. 3A, step 5) one or more L1/L2 inter-cell mobility candidate cell configurations; performing (FIG. 3A, step 10) a plurality of RLM processes based on parameters of one or more of a serving cell configuration and one or more of the L1/L2 inter-cell mobility candidate cell configurations; declaring (FIG. 3A, step 10) an RLF on one or more of the serving cell (304) or the one or more L1/L2 inter-cell mobility candidate cells (306); and performing (FIG. 3B, step 12 or 18) one or more actions based on whether the RLF is declared on a serving cell or at least one L1/L2 inter-cell mobility candidate cells.

Embodiment 2: The method of embodiment 1, wherein performing (FIG. 3B, step 12 or 18) one or more actions comprises performing (FIG. 3B, step 12) a first action if the RLF is declared on a serving cell or all of the L1/L2 inter-cell mobility candidate cells (306).

Embodiment 3: The method of embodiment 2, wherein the first action comprises triggering (FIG. 3B, step 12) a Radio Resource Control, RRC, re-establishment procedure.

Embodiment 4: The method of embodiment 1, wherein performing (FIG. 3B, step 12 or 18) one or more actions comprises performing (FIG. 3B, step 18) a second action if the RLF is declared on only a subset of the L1/L2 inter-cell mobility candidate cells (306).

Embodiment 5: The method of embodiment 4, wherein the second action comprises sending a report to a network node.

Embodiment 6: The method of any of embodiments 1-5, wherein the receiving the one or more L1/L2 inter-cell mobility candidate cell configurations comprises receiving the one or more L1/L2 inter-cell mobility candidate cell configurations via layer 1 signaling.

Embodiment 7: The method of any of embodiments 1-6, wherein the performing the plurality of RLM processes comprises: monitoring a first set of RLM-Reference Signals, RS, of the serving cell (304); and monitoring a second set of RLM-RS of a target candidate cell (306).

Embodiment 8: The method of embodiment 7, wherein the first set of RLM-RS of the serving cell comprise one or more of: one or more reference signals on one or more beams used for transmissions in the serving cell (304) of control and data channels; one or more Synchronization Signal Blocks, SSBs, or Channel State Information Reference Signals, CSI-RSs, configured as a Quasi-Colocation, QCL, source of a currently activated Transmission Configuration State, TCI, state of the serving cell (304); one or more reference signals one or more beams configured in the serving cell configuration; and one or more SSBs and/or CSI-RS configured in the serving cell configuration.

Embodiment 9: The method of embodiment 7, wherein the second set of RLM-RS of the serving cell comprise one or more of: one or more reference signals on one or more beams which are being indicate for the transmissions of control and data channels; one or more SSBs and/or CSI-RS configured as QCL source of the TCI state(s) of the target candidate cell (306); one or more reference signals on one or more beams configured for RLM in the target candidate cell configuration; and one or more SSBs and/or CSI-RSs configured for RLM in the target candidate cell configuration.

Embodiment 10: The method of any of embodiments 7-9, further comprising: generating an Out of Sync, OOS, indication for the target candidate cell (306) if all RLM-RSs in the second set of RLM-RSs are below a predefined threshold.

Embodiment 11: A User Equipment device, UE, (302) comprising a memory that stores computer-executable instructions; and a processor that executes the computer-executable instruction to perform operations, comprising: receiving (FIG. 3A, step 5) one or more L1/L2 inter-cell mobility candidate cell configurations; performing (FIG. 3A, step 10) a plurality of Radio Link Monitoring, RLM, processes based on parameters of one or more of a serving cell configuration and one or more of the L1/L2 inter-cell mobility candidate cell configurations; declaring (FIG. 3A, step 10) a Radio Link Failure, RLF, on one or more of the serving cell (304) or the one or more L1/L2 inter-cell mobility candidate cells (306); performing (FIG. 3B, step 12 or 18) one or more actions based on whether the RLF is declared on a serving cell or at least one L1/L2 inter-cell mobility candidate cell.

Embodiment 12: The UE (302) of embodiment 11, configured to perform the method of any one of embodiments 1-10.

Embodiment 13: A method performed by a first network node (304) for performing Radio Link Monitoring, RLM, and Radio Link Failure, RLF, detection, the method comprising: receiving (FIG. 3B, 12 or 18), from User Equipment device, UE, (302) an indication that a RLF has been declared on one or more L1/L2 inter-cell mobility cells for which a configuration has been provided to the UE (302) by the first network node; providing (FIG. 3B, step 22) to the UE (302) a new Radio Resource Control, RRC, message, the RRC message comprising at least one of: a configuration to reconfigure the L1/L2 inter-cell mobility cell; a layer 1 signaling indicating L1/L2 inter-cell mobility execution to a L1/l2 inter-cell mobility candidate cell; and an indication to remove the L1/L2 inter-cell mobility cell; providing (FIG. 3B, step 13 or 19) a message to a second network node, the message comprising at least one of: an indication on which L1/L2 inter-cell mobility cell the RLF was declared; an indication that a layer 1 signal indicating L1/L2 inter-cell mobility execution to a L1/L2 inter-cell mobility candidate cell has been sent to the UE (302); and a new configuration for L1/L2 inter-cell mobility to be sent to the UE (302).

Embodiment 14: The method of embodiment 13, wherein the new RRC message comprises a configuration to reconfigure the L1/L2 inter-cell mobility cell on which the RLF was declared.

Embodiment 15: A method performed by a first network node (308) for performing Radio Link Monitoring, RLM, and Radio Link Failure, RLF, detection, the method comprising: receiving (FIG. 3B, step 13 or 19) from a second network node (304, 306) a message comprising at least one of: an indication on which L1/L2 inter-cell mobility cell (304, 306) of a group of L1/L2 inter-cell mobility cells (304, 306) a RLF was declared by a User Equipment device, UE (302); an indication that layer 1 signal indicating L1/L2 mobility execution to a L1/L2 inter-cell mobility candidate cell (306) has been sent to the UE (302); and a new configuration for L1/L2 inter-cell mobility to be sent to the UE (302); providing (FIG. 3C, step 22) a message to the UE (302), wherein the message includes a new configuration for L1/L2 inter-cell mobility.

Embodiment 16: The method of embodiment 15, wherein the new configuration comprises a configuration to reconfigure (add/modify/release) the L1/L2 inter-cell mobility cell on which the RLF was declared.

Embodiment 17: A network node (308), comprising: a memory that stores computer-executable instructions; and a processor that executes the computer-executable instruction to perform operations, comprising: receiving (13, 19) from another network node (304, 306) a message comprising at least one of: an indication on which L1/L2 inter-cell mobility cell (304, 306) of a group of L1/L2 inter-cell mobility cells (304, 306) a RLF was declared by a User Equipment device, UE (302); an indication that layer 1 signal indicating L1/L2 mobility execution to a L1/L2 inter-cell mobility candidate cell has been sent to the UE (302); and a new configuration for L1/L2 inter-cell mobility to be sent to the UE (302); providing (22) a message to the UE (302), wherein the message includes a new configuration for L1/L2 inter-cell mobility.

Embodiment 18: The network of embodiment 17, configured to perform the method of any one of embodiments 13-16.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Function |
| AN | Access Network |
| AP | Access Point |
| ASIC | Application Specific Integrated Circuit |
| AUSF | Authentication Server Function |
| CPU | Central Processing Unit |
| DN | Data Network |
| DSP | Digital Signal Processor |
| eNB | Enhanced or Evolved Node B |
| EPS | Evolved Packet System |
| E-UTRA | Evolved Universal Terrestrial Radio Access |
| FPGA | Field Programmable Gate Array |
| gNB | New Radio Base Station |
| gNB-DU | New Radio Base Station Distributed Unit |
| HSS | Home Subscriber Server |
| IoT | Internet of Things |
| IP | Internet Protocol |
| LTE | Long Term Evolution |
| MME | Mobility Management Entity |
| MTC | Machine Type Communication |
| NEF | Network Exposure Function |
| NF | Network Function |
| NR | New Radio |
| NRF | Network Function Repository Function |
| NSSF | Network Slice Selection Function |
| OTT | Over-the-Top |
| PC | Personal Computer |
| PCF | Policy Control Function |
| P-GW | Packet Data Network Gateway |
| QoS | Quality of Service |
| RAM | Random Access Memory |
| RAN | Radio Access Network |
| ROM | Read Only Memory |
| RRH | Remote Radio Head |
| RTT | Round Trip Time |
| SCEF | Service Capability Exposure Function |
| SMF | Session Management Function |
| UDM | Unified Data Management |
| UE | User Equipment |
| UPF | User Plane Function |

Those skilled in the art will recognize improvements and modifications to the embodiments of the present disclosure. All such improvements and modifications are considered within the scope of the concepts disclosed herein.

1. A method performed by a User Equipment device, UE, configured with one or more L1/L2 inter-cell mobility candidate cells for performing Radio Link Monitoring, RLM, and Radio Link Failure, RLF, detection, the method comprising:
receiving one or more L1/L2 inter-cell mobility candidate cell configurations;
performing a plurality of RLM processes based on parameters of one or more of a serving cell configuration and one or more of the L1/L2 inter-cell mobility candidate cell configurations;
declaring an RLF on one or more of the serving cell or the one or more L1/L2 inter-cell mobility candidate cells; and
performing a network operation based on a type of the RLF.

2. The method of claim 1, wherein the type of the RLF is an RLF declared on either the serving cell or all of the L1/L2 inter-cell mobility candidate cells.

3. The method of claim 2, wherein the performing the network operation further comprises:
receiving a Radio Resource Control, RRC, re-establishment procedure.

4. The method of claim 1, wherein the type of the RLF is an RLF declared on a subset of L1/L2 inter-cell mobility candidate cells of the L1/L2 inter-cell mobility candidate cells.

5. The method of claim 1, wherein the receiving the one or more L1/L2 inter-cell mobility candidate cell configurations is via layer 1 signaling.

6. The method of claim 1, wherein the plurality of RLM processes comprise:
monitoring a first set of RLM-Reference Signals, RS, of the serving cell; and
monitoring a second set of RLM-RS of a target candidate cell.

7. The method of claim 6, wherein the first set of RLM-RS of the serving cell comprise one or more of:
one or more beams used for transmissions in the serving cell of control and data channels;
one or more Synchronization Signal Blocks, SSBs, or Channel State Information Reference Signals, CSI-RSs, configured as a Quasi-Colocation, QCL, source of a currently activated Transmission Configuration State, TCI, state of the serving cell;
one or more beams configured in the serving cell configuration; and
one or more SSBs and/or CSI-RS configured in the serving cell configuration.

8. The method of claim 6, wherein the second set of RLM-RS of the serving cell comprise one or more of:
one or more beams which are being indicate for the transmissions of control and data channels;
one or more SSBs and/or CSI-RS configured as QCL source of the TCI state(s) of the target candidate cell;
or more beams configured for RLM in the target candidate cell configuration; and
one or more SSBs and/or CSI-RSs configured for RLM in the target candidate cell configuration.

9. The method of claim 6, further comprising:
generating an Out of Sync, OOS, indication for the target candidate cell if all RLM-RSs in the second set of RLM-RSs are below a predefined threshold.

10. A User Equipment device, UE, comprising
a memory that stores computer-executable instructions; and
a processor that executes the computer-executable instruction to perform operations, comprising:
receiving one or more L1/L2 inter-cell mobility candidate cell configurations;
performing a plurality of Radio Link Monitoring, RLM, processes based on parameters of one or more of a serving cell configuration and one or more of the L1/L2 inter-cell mobility candidate cell configurations;
declaring a Radio Link Failure, RLF, on one or more of the serving cell or the one or more L1/L2 inter-cell mobility candidate cells;
performing a network operation based on a type of the RLF.

11. The UE of claim 10, wherein the type of the RLF is an RLF declared on either the serving cell or all of the L1/L2 inter-cell mobility candidate cells.

12. The UE of claim 11, wherein the processor is further configured to:
receive a Radio Resource Control, RRC, re-establishment procedure.

13. The UE of claim 10, wherein the type of the RLF is an RLF declared on a subset of L1/L2 inter-cell mobility candidate cells of the L1/L2 inter-cell mobility candidate cells.

14. The UE of claim 10, wherein the receiving the one or more L1/L2 inter-cell mobility candidate cell configurations is via layer 1 signaling.

15. The UE of claim 10, wherein the plurality of RLM processes comprise:
monitoring a first set of RLM-Reference Signals, RS, of the serving cell; and
monitoring a second set of RLM-RS of a target candidate cell.

16. The UE of claim 15, wherein the first set of RLM-RS of the serving cell comprise one or more of:
one or more beams used for transmissions in the serving cell of control and data channels;
one or more Synchronization Signal Blocks, SSBs, or Channel State Information Reference Signals, CSI-RSs, configured as a Quasi-Colocation, QCL, source of a currently activated Transmission Configuration State, TCI, state of the serving cell;
one or more beams configured in the serving cell configuration; and
one or more SSBs and/or CSI-RS configured in the serving cell configuration.

17. The UE of claim 15, wherein the second set of RLM-RS of the serving cell comprise one or more of:
one or more beams which are being indicate for the transmissions of control and data channels;
one or more SSBs and/or CSI-RS configured as QCL source of the TCI state(s) of the target candidate cell;
or more beams configured for RLM in the target candidate cell configuration; and
one or more SSBs and/or CSI-RSs configured for RLM in the target candidate cell configuration.

18. The UE of claim 15, further comprising:
generating an Out of Sync, OOS, indication for the target candidate cell if all RLM-RSs in the second set of RLM-RSs are below a predefined threshold.

19. A method performed by a first network node of a serving cell for performing Radio Link Monitoring, RLM, and Radio Link Failure, RLF, detection, the method comprising:
receiving, from User Equipment device, UE, an indication that an RLF has been declared on a L1/L2 inter-cell mobility cell for which a configuration has been provided to the UE by the first network node;
providing to the UE a new Radio Resource Control, RRC, message, the RRC message comprising at least one of:
a configuration to reconfigure the L1/L2 inter-cell mobility cell;
a layer 1 signaling indicating L1/L2 inter-cell mobility execution to a L1/l2 inter-cell mobility candidate cell; and
an indication to remove the L1/L2 inter-cell mobility cell;
providing a message to a second network node, the message comprising at least one of:
an indication on which L1/L2 inter-cell mobility cell the RLF was declared;
an indication that a layer 1 signal indicating L1/L2 inter-cell mobility execution to a L1/L2 inter-cell mobility candidate cell has been sent to the UE; and
a new configuration for L1/L2 inter-cell mobility cell to be sent to the UE.

20-22. (canceled)

23. A method performed by a first network node of a Central Unit, CU, for performing Radio Link Monitoring, RLM, and Radio Link Failure, RLF, detection, the method comprising:
receiving from a second network node of a serving cell or a candidate cell a message comprising at least one of:
an indication on which L1/L2 inter-cell mobility cell of a group of L1/L2 inter-cell mobility cells a RLF was declared by a User Equipment device, UE;
an indication that layer 1 signal indicating L1/L2 mobility execution to a L1/L2 inter-cell mobility candidate cell has been sent to the UE; and
a new configuration for L1/L2 inter-cell mobility to be sent to the UE;
providing a message to the UE, wherein the message includes a new configuration for L1/L2 inter-cell mobility.

24-26. (canceled)
